(19) United States
(12) Patent Application Publication
(10) Pub. No.: US 2002/0080782 A1
(43) Pub. Date: Jun. 27, 2002

(54) Method and system for central control of terminal units

(75) Inventors: Joel S. Dick, Garland, TX (US); Richard R. Gelling, Rowlett, TX (US)

Correspondence Address: Barton E. Showalter, Baker Botts L.L.P., 2001 Ross Avenue, Dallas, TX, 75201-2980, US

(73) Assignee: Broadband Gateways, Inc.

(21) Appl. No.: 09/746,150

(22) Filed: Dec. 22, 2000

(51) Int. Cl. H04Q 11/00; H04L 12/50

(52) U.S. Cl. 370/362; 370/389

(57) ABSTRACT

A communication system includes a central processor operable to transmit data packets and control packets. A communication bus couples the central processor to a transmit/receive module, for communicating the data packets and control packets between the central processor and the transmit/receive module. In a particular embodiment, a plurality of terminal unit control modules are coupled with the central processor, and each terminal unit control module is operable to control at least partially the operation of a respective one of the terminal units.

### TECHNICAL FIELD OF THE INVENTION

The present invention relates generally to network communication and, more particularly to a method and system for central control of terminal units.

### BACKGROUND OF THE INVENTION

Communication systems are often used to monitor and/or control a number of terminal units. The communication system may also receive data from an external network, and distribute a portion of the data to one or more of the terminal units. Such terminal units may include personal computers, laptops, personal digital assistants or other communication and/or computing devices. Wireless and wireline technologies may be employed to couple the communication system with the terminal units.

Data transferred between the network and the terminal units include voice, video, data, control and/or other signals. Furthermore, the communication system may be coupled with a local area network, wide area network, metropolitan area network or any telecommunication network.

### SUMMARY OF THE INVENTION

The present invention provides a method and system for central control of terminal units that substantially eliminate or reduce the problems and disadvantages associated with the previous systems and methods. In particular embodiments, high level control, intelligence and attributes of a plurality of terminal units are accomplished and/or stored at a communication system which reduces the hardware and/or software requirements, and thereby the cost and complexity of each terminal unit. Furthermore, the flexibility and operation of the system is enhanced.

In a particular embodiment, a communication system includes a central processor operable to transmit data packets and control packets to a transmit/receive module, using a communication bus. The transmit/receive module may be used to transmit the data packets and control packets to one of the terminal units. A plurality of terminal unit control modules are coupled with the central processor, and each terminal unit control module is operable to control at least partially the operation of a respective one of the plurality of terminal units.

In accordance with a particular embodiment of the present invention, a first communication bus is provided for communication of the data packets between the central processor and the transmit/receive module. A second communication bus may also be provided for communication of the control packets between the central processor and the transmit/receive module.

In accordance with another aspect of the present invention, a script module may be coupled with the central processor. The script module may be operable to determine the content of the control packets.

Technical advantages of certain embodiments of the present invention include a communication system which may be coupled with a plurality of terminal units such that the terminal units operate subject to the control of the communication system. Accordingly, processing power and memory requirements of each terminal unit is reduced, thereby reducing the cost and complexity of each terminal unit.

Another technical advantage of certain embodiments of the present invention include terminal units having respective dedicated control modules at the communication system. Therefore, the behavior script model, functionality, and attributes of a particular terminal unit(s) may be enhanced, altered and/or modified at the communication system without any hardware or software modifications accomplished at the physical location of the terminal units.

Other technical advantages of the present invention will be readily available to one skilled in the art from the following figures, descriptions, and claims.

### BRIEF DESCRIPTION OF THE DRAWINGS

For a more complete understanding of the present invention and its advantages, reference is now made to the following descriptions, taken in conjunction with the accompanying drawings, in which:

FIG. 1 is a block diagram illustrating a communication system incorporating aspects of the present invention, which couples a communication network with one or more terminal units;

FIG. 2A is a block diagram illustrating the communication system of FIG. 1, in accordance with a particular embodiment of the present invention;

FIG. 2B is a block diagram illustrating components of the terminal unit of FIG. 1, in accordance with a particular embodiment of the present invention;

FIG. 3 is a block diagram illustrating a method for transmitting control packets and data packets between the communication system and terminal unit of FIG. 1, in accordance with a particular embodiment of the present invention; and

FIG. 4 is a block diagram illustrating a call processing model, in accordance with a particular embodiment of the present invention.

### DETAILED DESCRIPTION OF THE INVENTION

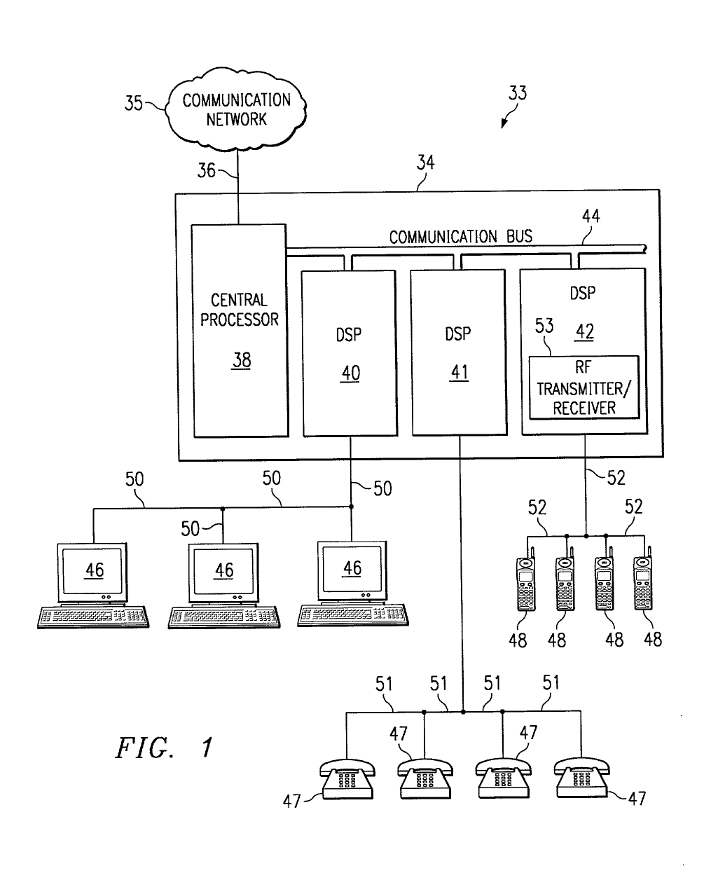

FIG. 1 illustrates a network 33 which includes a communication system 34 coupled with a communication network 35 and a plurality of terminal units 46-48. Communication system 34 is configured to provide two way communication between communication network 35 and each terminal unit 46-48. Accordingly, communication system 34 provides an interface between each terminal unit 46-48 and communication network 35, and also provides high level control and operation features and functionality to each terminal unit 46-48. This reduces the hardware and/or software requirements of each individual terminal unit 46-48 and provides greater flexibility, functionality and reduced cost to each terminal unit 46-48.

Communication system 34 is coupled with communication network 35, through a communication link 36. In a particular embodiment, communication system 34 includes a telecommunications system network access element that provides access to broadband networks, and includes the ability to deliver intelligent voice, data and multimedia services. Voice, video, data, control and/or other signals are distributed between communication network 35 and communication system 34. Signals received by communication system 34 are processed at a central processor 38, and distributed to one or more of a plurality of processors 40-42, using a communication bus 44. In the illustrated embodiment, processors 40-42 are digital signal processors (DSPs), configured to transmit and/or receive data to and from terminal units 46-48.

Terminal units 46 are desktop personal computers (PCs), laptops, PDAS, or other devices coupled with one another and processor 40 of communication system 34, through communication links 50. Each terminal unit 46 is Internet-enabled and includes a web browser for accessing the World Wide Web (WWW), through communication network 35. Terminal units 46 also include the ability to communicate with one another, and other terminal units 47 and 48 coupled with communication system 34.

Terminal units 47 are telephone extensions coupled with processor 41 of communication system 34 through communication links 51. In particular embodiments, terminal extensions 47 may include various analog, digital, and/or other wireline voice communication devices. Terminal units 47 accommodate wireline telephone communications with each other, network 35, and other terminal units 46 and 48 coupled with communication system 34. Terminal units 47 are also configured to receive control information from communication system 34, and operate subject to the intelligence of communication system 34.

Terminal units 48 are wireless handsets coupled with processor 42 of communication system 34, through wireless communication links 52. Accordingly, processor 42 is coupled with an associated radio frequency (RF) transmitter/receiver 53 for the transfer of data between processor 42 and terminal units 48. Data may be sent and received by and among each of terminal units 48, communication system 34, network 35, and other terminal units 46 and 47 coupled with communication system 34. Although FIG. 1 illustrates terminal units 46-48, network 33 contemplates any arrangement or number of computing and/or communication devices coupled with communication system 34 using wireless and/or wireline techniques.

Communication system 34 accommodates the transfer of data between network 35 and terminal units 46-48. Communication link 36 may be an asymmetric digital subscriber line (ADSL), VDSL, HDSL, SDSL, xDSL, or other high speed data transmission technology that uses unshielded twisted pair (UTP) copper wires from the central office of a telephone company to the subscribers premises. In another embodiment, communication link 36 may include any high speed communication link including, without limitation, copper, optical, cable or wireless links. Link 36 transfers data from communication system 34 to network 35 and from network 35 to communication system 34. When using ADSL as link 36, the rate at which data is received at communication system 34 is greater than the rate at which data is sent from communication system 34, which accounts for the term “asymmetric” digital subscriber line.

Communication network 35 incorporates both asynchronous and synchronous transmission equipment and technologies. In this manner, network 35 may communicate with a number of different telecommunication networks and products using various data transfer rates, standards and protocols of the telecommunications and network communications industries. Therefore, communication network 35 receives, processes, and/or transmits analog and/or digital signals. Accordingly, communication link 36 and communication system 34 are configured to receive data at different rates of transfer. In a particular embodiment, data packets received at communication system 34 through communication link 36 are asynchronous data packets, and the rate at which the packets are received and transferred to central processor 38 varies according to the specifications of the system sending the data.

Communication bus 44 distributes data and information between central processor 38 and processors 40-42. Bus 44 is a bi-directional, multi-rate communication bus. In other words, communication bus 44 is configured to perform two-way communication between components of communication system 34. Central processor 38 transfers data to processor 42, for example, and processor 42 transfers data to central processor 38. In a particular embodiment, communication bus 44 may handle two-way communication, simultaneously.

Communication bus 44 is time-division multiplexed. Accordingly, bus 44 accommodates synchronous data transfer between central processor 38 and processors 40-42. Therefore, asynchronous data packets received at central processor 38 are converted to synchronous data packets for transfer over communication bus 44. However, in a particular embodiment, terminal units 46-48 are configured to receive standard asynchronous data transfer. Hence, the synchronous data packets transmitted using communication bus 44 are converted back to asynchronous data packets at one or more of processors 40-42, for transfer to one or more of terminal units 46-48.

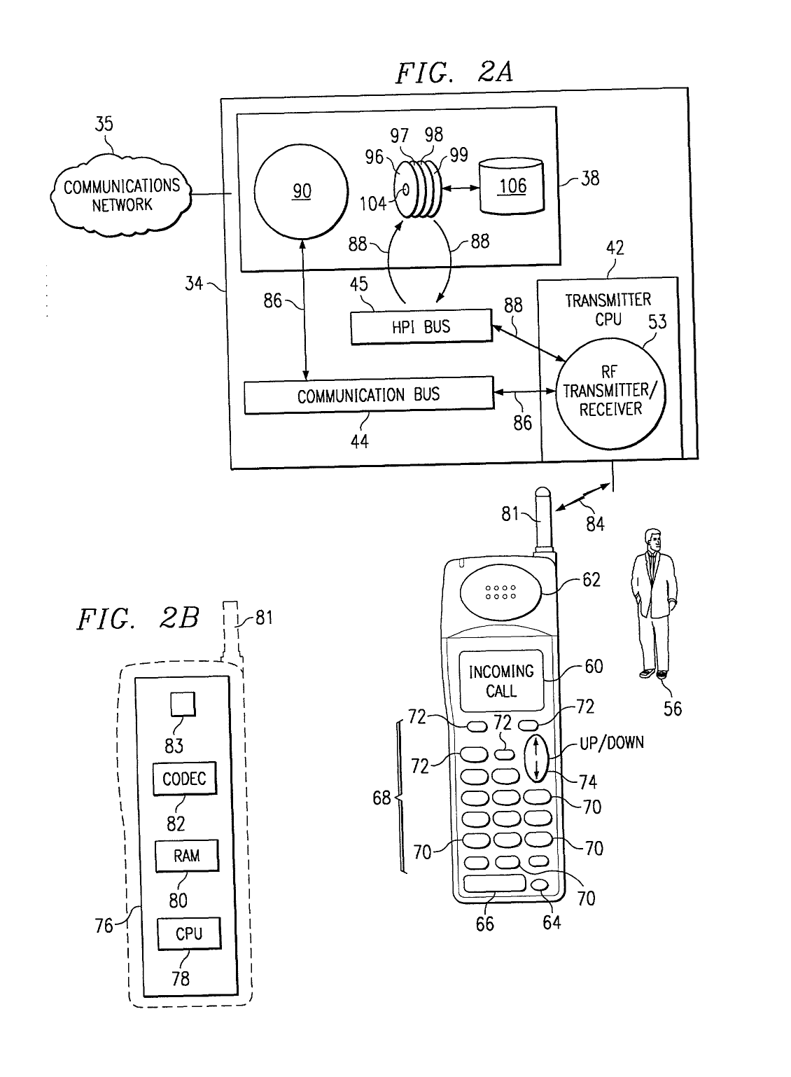

FIGS. 2A and 2B illustrate additional components of communication system 34 and terminal unit 48. For illustrative purposes, the operation of communication system 34 will be described herein with respect to a wireless handset terminal unit 48. However, in another embodiment, terminal unit 48 may include any of various wireless or wireline computing and/or communication devices.

Handset 48 allows an operator 56 of handset 48 to access functions and services available from communication system 34 and network 35. Accordingly, communication system 34 and handset 48 each include hardware and/or software to provide two-way communication between system 34 and handset 48. In a particular embodiment, the amount of hardware and/or software provided at handset 48 is minimized in order to provide maximum control and modularity to system 34, and flexibility, scalability, replaceability, configurability and minimum cost to each handset 48 (and/or other terminal units 46-47, as the case may be).

In the illustrated embodiment, communication system 34 and handset 48 cooperate to provide a 900 MHz wireless phone system. Communication system 34 includes the memory and processing capacity to store and control attributes of each handset 48. Attributes of a particular handset include speed dial numbers, extension names, memory keys, phone book entries, and other information available to an operator 56 of handset 58. By storing and controlling handset attributes using communication system 34, the attributes are catalogued in a central repository and need not be separately maintained by each handset 48. This reduces the hardware and/or software requirements of each handset 48.

A portion of the central logic and intelligence for each handset 48 is also maintained, controlled and operated by communication system 34. Each handset 48 includes the hardware and/or software necessary to execute control commands and functionality requests received from communication system 34. Control commands executed by each handset include such functions as clear display, set display characters, play ringer tone, play speaker tone, go on hook, go off hook, and/or any other functional command suitable for execution by a terminal unit. Therefore, in a particular embodiment, the hardware and/or software included with each handset 48 is generally limited to that necessary to accommodate two way voice and/or data communication, and to carry out the commands, actions and functions available from communication system 34.

Handset 48 includes a multi-line, textual liquid crystal display (LCD) 60, speaker 62, ringer 64, microphone 66 and an alphanumeric telephone keypad 68. LCD 60 is used to display data and text to operator 56 of handset 48 in order to enhance and simplify the use of handset 48. In particular embodiments, LCD 60 is used to provide a menu of selections available to operator 56, as will be described later in more detail. In response to such selections, operator 56 may specify a particular function by depressing one or more numeric keys 70 and/or function keys 72. Additional information is displayed by LCD 60 including battery life remaining, time, date, telephone number called, telephone number of caller (caller ID), volume level and/or text messages. A volume key 74 is also provided to allow operator 56 to increase or decrease the volume of speaker 62, as appropriate.

Internally, as illustrated in FIG. 2B, handset 48 includes a printed circuit board 76 which couples a central processor (CPU) 78, random access memory (RAM) 80, coder-decoder (codec) 82, and command interpreter 83. Handset 48 also includes an antenna 81 which wirelessly couples handset 48 with communication system 34 using a radio frequency (RF) communication link 84. CPU 78 includes hardware and/or software for the receipt/transmission and compression/decompression of voice-data packets across RF link 84. Therefore, CPU 78 allows scrolling of menus which are downloaded (temporarily) into a memory buffer associated with CPU 78 which the user may access during a particular communication session. The user may select a function from the menu by depressing a function key 72. In the illustrated embodiment, the RF link of FIG. 2 is a 900 MHz RF link.

As previously discussed, communication system 34 includes central processor 38 and processor 42 which are coupled for two way communication with one another using communication bus 44. A second communication bus 45 is also provided, and forms a second path of communication between central processor 38 and processor 42. Central processor 38 includes a voice data module 90, which is operable to receive asynchronous data packets, and route the data packets to processor 42, via communication bus 44. In the illustrated embodiment, processor 42 is an RF transmitter/receiver CPU. Accordingly, processor 42 includes an RF transmitter/receiver 53 which transmits the data packets to handset 48 over RF link 84. RF transmitter/receiver 53 may include one or more DSPs.

Two types of packets are transmitted between central processor 38 and processor 42. Data and voice packets 86 (hereinafter “data packets”) are transferred from central processor 38 to processor 42 over communication bus 44. Data packets 86 refer to packets containing voice packets and/or data packets used to transfer voice signals for broadcasting over speaker 62, and data packets containing data to be displayed by LCD 60. Control and command packets 88 (hereinafter “control packets”) are also transferred between central processor 38 and processor 42. Control packets 88 refer to packets which contain signals and/or information regarding the control, command, and/or coordination of functionality of handset 48.

In a particular embodiment, control packets 88 are transferred between processor 38 and processor 42 using communication bus 45. Therefore, data packets 86 and control packets 88 are transferred over separate communication buses 44 and 45, respectively. However, in another embodiment, data packets 86 may share a common communication bus, or another distribution of communication paths for data and control packets may be provided which includes two or more communication buses. The distribution and type of data and information packets transmitted using each bus 44 and 45 may be modified and/or redistributed significantly, in various embodiments.

As described above, communication bus 44 is a time-division multiplexed bus operable to transmit data packets 86. In the illustrated embodiment, communication bus 45 is a Host Port Interface (HPI) bus operable to transmit control packets 88 from central processor 38 to processor 42. HPI is a communication method for inter-processor communication between DSPs.

Data packets 86 generated by handset 48 are transmitted from handset 48 to RF transmitter/receiver 53, using communication link 84. Data packets 86 are transferred from processor 42 to voice data module 90 of central processor 38 using communication bus 44, for further processing. Similarly, control packets 88 generated by handset 48 are transferred to RF transmitter/receiver 53 using communication link 84. Control packets 88 are transferred to a handset control module 96 using communication bus 45, for further processing.

Central processor 38 coordinates, monitors and controls the operation of each associated terminal unit 46-48. Central processor 38 is coupled with a plurality of handset control modules 96-99, each of which manages and controls a respective terminal unit 46-48. For example, handset 48 of FIG. 2, operates subject to the control of control module 96. Control modules 96-99 generate control packets 88 for transmission to their respective handset 48. Such control packets 88 are initiated at the control module 96-99 and transmitted over communication bus 45. In particular embodiments, control modules 96-99 may be software processes each created to control a particular handset 48.

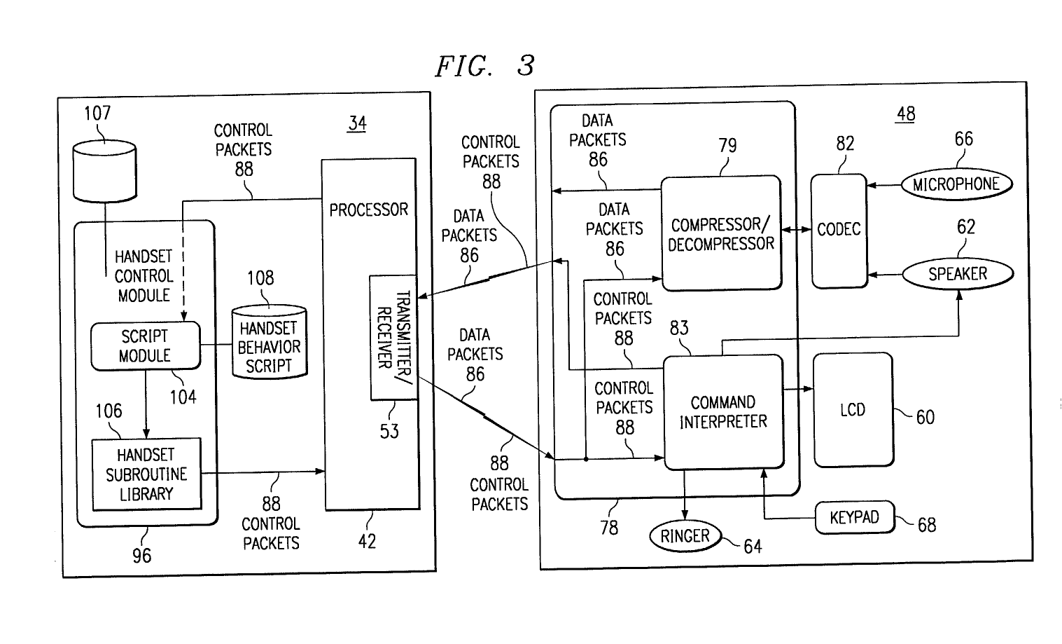

Each control module 96-99 is coupled with a script module 104 operable to define, perform and/or store high-level handset behavior logic, subroutines and/or attributes. Script module 104 is coupled with a handset behavior script 108 and handset subroutine library 106. The function of script module 104 will be described in more detail, with regard to FIG. 3.

FIG. 3 illustrates additional components of handset 48 and communication system 34. RF transmitter/receiver 53 of communication system 34 transmits both data packets 86 and control packets 88 to handset 48. In a particular embodiment, a continuous stream of data packets 86 are sent to handset 48. Control packets 88 are sent to handset 48 by inserting the control packets 88 into the stream of data packets 86.

CPU 78 of handset 48 receives data packets 86 and control packets 88 and separates the data packets 86 from the control packets 88, for further processing. Data packets 86 are transmitted to compressor/decompressor 70 where the data packets 86 are decompressed and transmitted to codec 82. Codec 82 translates data packets 86 and transmits the data packets 86 to speaker 62, for presentation to operator 56. Although the illustrated embodiment includes compressor/decompressor 70 and codec 82, it will be recognized by those of ordinary skill in the art that a single codec may be used to replace the functionality of both compressor/decompressor 70 and coded 82.

Command packets 88 are transmitted from transmitter/receiver 53 of communication system 34 to CPU 78 of handset 48. A command interpreter 83 is coupled with or integral to CPU 78. Command interpreter 83 processes control packets 88, and the discrete action requested by the control packet 88 is executed by CPU 78 (e.g., handset displays “incoming call” on LCD 60).

There are a variety of “states” that a given handset 48 may be in, at any given time. Such states include, without limitation, “ringing”, “power-on”, “power-off”, “on-hook” and/or “off-hook”. Similarly, there are a variety of events that can occur while the handset is in a given state. Events may correspond to user interaction at the handset, for example, depressing a key on the keypad. Events can also occur from outside the handset, for example, central processor 38 may detect a request to ring a specific telephone number assigned to handset 48. Communication system 34 at least partially defines and controls the states and events available to handset 48, and determines the actions necessary to execute commands in response to events and requests.

For example, if central processor 38 detects a request from communication network 35 to ring terminal unit 48, this request is transmitted to script module 104. In response, script module 104 accesses handset behavior script database 108 in order to determine the handset subroutines necessary to carry out the function. Handset behavior script database 108 communicates the scripts, or subroutines which should be executed. Such subroutines include a subroutine necessary to ring ringer 64 and another subroutine necessary to display “incoming call” on LCD 60. Accordingly, handset behavior script module 108 helps script module 104 establish how many, and which specific subroutines must be transmitted to handset 48.

Next, script module 104 will transmit identifiers to handset subroutine library 106 which indicate which subroutines are necessary to carry out the action. In response, handset subroutine library 106 transmits each subroutine and the associated commands and actions to control module 96, in the form of control packets 88. Control module 96 then transmits the control packets 88 associated with the subroutines to handset 48, for execution.

Referring again to FIG. 3, when operator 56 executes a command at handset 48 (e.g., operates keypad 68) the action is relayed back to handset control module 96, as a control packet 88. Accordingly, the handset event is encapsulated in an asynchronous control packet 88. Handset control module 96 transmits the handset event to script module 104. Based upon the current state of the handset script, script module 104 interprets the event and determines the appropriate response and actions, using handset subroutine library 106 and handset behavior script database 108. The commands necessary for handset 48 to carry out the actions are transmitted to handset 48. An example of the results of these commands is for handset 48 to display new information on LCD 60, or execute a speaker tone (e.g., dial tone) at speaker 62 of handset 48. The command/action sequence continues until the handset operation ceases, or communication system 34 is shut down.

The logic for generating display data and interpreting button-presses of handset 48 resides in handset control module 96. Similarly, handset attributes are stored in a single attribute repository module 107 of communication system 34, for access by handset 48. As previously described, examples of handset attributes include the textual user name, and/or the speed dial numbers associated with a particular handset 48. The attributes are cataloged in handset attribute repository module 107, and do not occupy space in RAM 80 of handset 48. Accordingly, the capacity of RAM 80 is reduced which reduces the size, complexity and cost of handsets 48.

Handset 48 includes hardware and/or software, which interpret control packets 88 received from transmitter/receiver 53 of communication system 34, and carry out the requested operation on hardware components of handset 48. For example, a control packet including a command to display the caller's telephone number of an incoming telephone call on the first line of LCD 60 (e.g., “(555)555-5555”), may be received by handset 48. Alternatively, handset 48 may receive a control packet 88 including a command to generate a dial tone on speaker 62. Hardware and/or software associated with handset 48 allow hardware components of handset 48 to respond to operator's 56 operation of the handset by generating and transmitting data packets 86 and control packets 88 to communication system 34, via RF link 84.

Script module 104 includes the Intellihome Meta-Language (IHML), a state-based scripting language that can be compiled to byte code, and implement a centralized controller. Additional details regarding the IHML can be found in U.S. Ser. No. 08/941,794, entitled Method and Apparatus for Improved Building Automation, now U.S. Pat. No. ______, which is hereby incorporated by reference, for all purposes. Script module 104 is operable to conduct routines necessary to read in a pre-compiled IHML script. Script module 104 receives notification of system events, parses the system event to determine the IHML scripted actions used to accomplish the requested events, and initiates the requested actions by executing subroutines from a handset subroutine library 106.

Script module 104 defines the states available to communication system 34 and handset 48, as well as the possible events that could potentially occur within such states. Therefore, script module 104 handles all generic functionality common to all handsets. For each event in a state, the necessary actions to act on that event are carried out. For example, scripting can include activation of ringer 64 followed by the display of a series of text messages on LCD 60. Activation of ringer 64 occurs while handset 48 is in the “ringing” state. One possible event that may be processed while handset 48 is in the ringing state includes a handset “off-hook” event. In this example, actions that can be taken may include:

taking handset 48 that is ringing “off-hook”;

sending a control packet(s) 88 to processor 42, which includes a command to begin routing data (voice) packets 86 from communication system 34 to handset 48;

sending a control packet(s) 88 to handset 48, which includes a command to clear LCD 60; and/or

transitioning the script of handset 48 to the “off-hook” state.

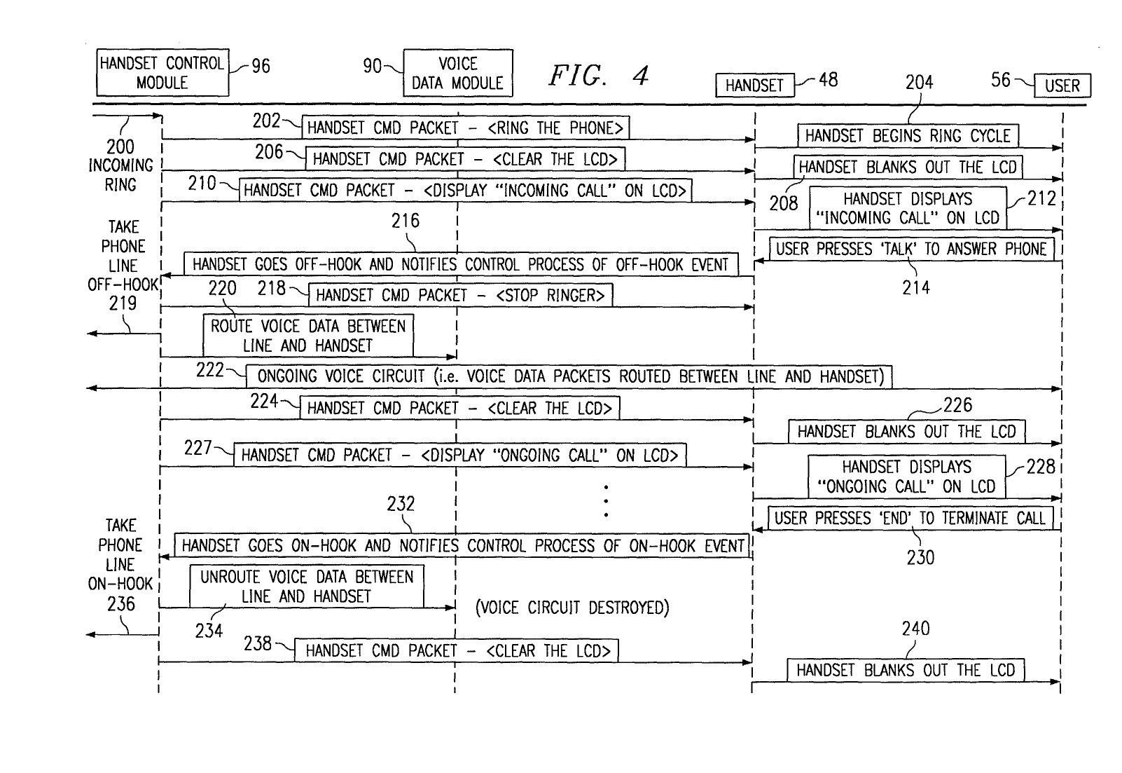

An example of various states and events carried out in an exchange between communication system 34 and handset 48 are illustrated and described with regard to FIG. 4.

To execute each of the necessary actions, script module 104 executes a callback function, providing an action string describing the requested action to be executed. The callback function parses the action string and calls the appropriate subroutine from handset subroutine library 106. Each subroutine contained in handset subroutine library 106 include commands which can be communicated to handset 48 to execute a discreet handset 48 operation. At process startup, the appropriate handset behavior script is loaded from handset behavior script database 108 into script module 104, and script module 104 sends the initial display information to handset 48 by making calls into handset subroutine library 106, via the “send” callback function. Each routine in the handset subroutine library 106 causes one or more action/requests to be sent to handset 48 to carry out an operation. The action/request is encapsulated as a control packet 88, sent to processor 42 via communication bus 45, and ultimately transmitted to handset 48 using RF link 84.

FIG. 4 illustrates an example of a call processing model available to communication system 34 and handset 48. At step 200, an incoming ring occurs and a handset packet 202 is transferred to handset 48, instructing handset 48 to “ring the phone”. Accordingly, handset 48 begins a ring cycle, at step 204. A second handset packet 206 is transferred to handset 48, instructing handset 48 to “clear LCD 60”, which causes the handset to blank out LCD 60, at step 208. A third handset packet 210 is transferred to handset 48 instructing handset 48 to “display ‘incoming call’ on LCD 60”. Therefore, at step 212, handset 48 displays “incoming call” on LCD 60.

In response to ringing and the “incoming call” display on LCD 60, operator 56 of handset 48 presses a function key 72, entitled “talk”, in order to connect the call, at step 214. Accordingly, handset 48 goes off-hook and a notification 216 is transmitted to handset control module 96. Notification 216 is received at handset control module 96 which transfers handset packet 218 to handset 48, instructing handset 48 to stop the ringer. At step 219, handset control module 96 takes the phone line “off-hook”. Voice and/or data are transferred between communication system 34 and handset 48 at step 220.

An ongoing voice circuit 222 is established between communication system 34 and operator 56 of handset 48. A handset packet 224 is transferred from handset control module 96 to handset 48 instructing handset 48 to “clear LCD 60”. Accordingly, LCD 60 is cleared at step 226. Another handset packet 227 is transferred to handset 48, instructing handset 48 to display “ongoing call” on LCD 60. At step 228, LCD 60 displays “ongoing call” on LCD 60.

At the conclusion of the call, operator 56 depresses a function key 72, entitled “end”, in order to terminate the call, at step 230. Accordingly, handset 48 issues a notification 232 to handset control module 96 to communicate the “on-hook” event. Therefore, the voice circuit is disconnected, and voice and data between communication system 34 and handset 48 are terminated, at step 234. Handset control module 96 takes the phone line on-hook at step 236. At the termination of the call, a handset packet 238 is transmitted to handset 48. Finally, at step 240, handset 48 clears LCD 60.

The central control of each handset accomplished by communication system 34 allows the “look and feel” of handset 48 to operator 56 to be completely reworked by swapping out behavior scripts in communication system 34, without necessitating any hardware or software modifications to the handset. Furthermore, the network architecture can support future handset designs by simple additions to a handset function library and behavior script, located at communication system 34.

Although the present invention has been described in several embodiments, a myriad of changes and modifications may be suggested to one skilled in the art, and it is intended that the present invention encompass such changes and modifications as fall within the scope of the present appended claims.

What is claimed is:

1. A communication system, comprising:
a central processor operable to transmit data packets and control packets;
a transmit/receive module operable to receive the data packets and the control packets and transmit the data packets and control packets to one of a plurality of terminal units;
a communication bus coupling the central processor to the transmit/receive module for communication of the data packets and the control packets; and
a plurality of terminal unit control modules coupled with the central processor, each terminal unit control module operable to control at least partially the operation of a respective one of the plurality of terminal units.

2. The communication system of claim 1, further comprising:
a script module coupled with at least one of the terminal unit control modules; and
wherein the script module is operable to determine the content of the control packets.

3. The communication system of claim 2, wherein the script module defines a plurality of states available to at least one of the terminal units, and the control packets include control information corresponding with at least one of the states.

4. The communication system of claim 2, wherein the script module defines a plurality of subroutines available to at least one of the terminal units, and the control packets include control information corresponding with at least one of the subroutines.

5. The communication system of claim 1, further comprising:
a terminal unit behavior script module coupled with at least one of the terminal unit control modules, the terminal unit behavior script module defining a plurality of subroutines available to at least one of the terminal units; and
wherein the control packets include information corresponding with at least one of the subroutines.

6. The communication system of claim 1, further comprising:
a terminal unit subroutine library coupled with at least one of the terminal unit control modules, the terminal unit subroutine library defining a plurality of commands associated with subroutines available to at least one of the terminal units; and
wherein the control packets include information corresponding with at least one of the commands.

7. The communication system of claim 1, further comprising:
a terminal unit attribute repository coupled with the terminal unit control modules; and
wherein the attribute repository includes attributes associated with at least one of the terminal units.

8. The communication system of claim 7, wherein the attributes include a speed dial telephone number, a memory key or a personal phone book entry.

9.The communication system of claim 1, further comprising:
a voice/data module coupled with the central processor; and
wherein the voice/data module is operable to determine the content of the data packets.

10. The communication system of claim 1, wherein the transmit/receive module is further operable to transmit data packets and control packets and the central processor is further operable to receive data packets and control packets transmitted by the transmit/receive module.

11. A communication system, comprising:
a central processor operable to transmit data packets and control packets;
a transmit/receive module operable to receive the data packets and the control packets and transmit the data packets and control packets to one of a plurality of terminal units;
a first communication bus coupling the central processor and the transmit receive module for communication of the data packets; and
a second communication bus coupling the central processor and the transmit/receive module for communication of the control packets.

12. The communication system of claim 11, further comprising a plurality of terminal unit control modules coupled with the central processor, each terminal unit control module operable to control the operation of a corresponding one of the terminal units.

13. The communication system of claim 11, further comprising:
a script module coupled with at least one of the terminal unit control modules; and
wherein the script module is operable to determine the content of the control packets.

14. The communication system of claim 13, wherein the script module defines a plurality of states available to at least one of the terminal units, and the control packets include control information corresponding with at least one of the states.

15. The communication system of claim 13, wherein the script module defines a plurality of subroutines available to at least one of the terminal units, and the control packets include control information corresponding with at least one of the subroutines.

16. The communication system of claim 11, further comprising:
a terminal unit behavior script module coupled with at least one of the terminal unit control modules, the terminal unit behavior script module defining a plurality of subroutines available to at least one of the terminal units; and
wherein the control packets include information corresponding with at least one of the subroutines.

17. The communication system of claim 11, further comprising:
a terminal unit subroutine library coupled with at least one of the terminal unit control modules, the terminal unit subroutine library defining a plurality of commands associated with subroutines available to at least one of the terminal units; and
wherein the control packets include information corresponding with at least one of the commands.

18. The communication system of claim 11, further comprising:
a terminal unit attribute repository coupled with the terminal unit control modules; and
wherein the attribute repository includes attributes associated with at least one of the terminal units.

19. The communication system of claim 18, wherein the attributes include a speed dial telephone number, a memory key or a personal phone book entry.

20. The communication system of claim 11, further comprising:
a voice/data module coupled with the central processor; and
wherein the voice/data module is operable to determine the content of the data packets.

21. The communication system of claim 11, wherein the transmit/receive module is further operable to transmit data packets and control packets and the central processor is further operable to receive data packets and control packets transmitted by the transmit/receive module.

22. A terminal unit, comprising:
a printed circuit board;
a processor coupled with the printed circuit board, the processor operable to receive control packets from one of a plurality of terminal unit control modules associated with a communication system.

23. The terminal unit of claim 22, wherein the processor is further operable to receive data packets from the communication system.

24. The terminal unit of claim 22, further comprising a command interpreter coupled with the processor, the command interpreter operable to receive commands associated with the control packets, and to control hardware components of the terminal unit.

25. The terminal unit of claim 22, further comprising:
a compressor/decompressor module coupled with the processor and operable to receive data packets from the processor and convert the data packets into voice packets;
a codec coupled with the compressor/decompressor, the codec operable to receive voice packets from the compressor/decompressor for transmission to a speaker associated with the terminal unit.

26. A method, comprising:
transmitting first control packets from a first terminal unit control module to a transmit/receive module;
transmitting second control packets from a second terminal unit control module to the transmit/receive module;
the first and second terminal unit control modules operable to control at least partially the operation of first and second terminal units, respectively; and
transmitting data packets from a processor to the transmit/receive module.

27. The method of claim 26, further comprising transmitting at least a portion of the control packets from the transmit/receive module to the first terminal unit.

28. The method of claim 26, wherein the first and second control packets are transmitted from the first and second terminal unit control modules to the transmit/receive module using a first communications bus, and the data packets are transferred from the processor to the transmit/receive module using a second communications bus.

29. The method of claim 26, further comprising transmitting information regarding the content of the first control packets from a script module to the first terminal unit control module.

30. The method of claim 29, further comprising transmitting terminal unit subroutine identifiers from a terminal unit behavior script database to the script module.

31. The method of claim 29, further comprising transmitting at least one subroutine from a terminal unit subroutine module to the script module.

32. The method of claim 26, further comprising:
coupling a terminal unit attribute repository to the processor; and
storing information regarding attributes of the first terminal unit at the terminal unit attribute repository.

33. A computer readable medium encoded with a computer program operable to:
transmit first control packets from a first terminal unit control module to a transmit/receive module;
transmit second control packets from a second terminal unit control module to the transmit/receive module;
the first and second terminal unit control modules operable to control at least partially the operation of first and second terminal units, respectively; and
transmit data packets from a processor to the transmit/receive module.

34. The computer readable medium of claim 33, wherein the computer program is further operable to transmit at least a portion of the control packets from the transmit/receive module to the first terminal unit.

35. The computer readable medium of claim 33, wherein the computer program is further operable to transmit information regarding the content of the first control packets from a script module to the first terminal unit control module.

36. A system, comprising:
means for transmitting first control packets from a first terminal unit control module to a transmit/receive module;
means for transmitting second control packets from a second terminal unit control module to the transmit/receive module;
the first and second terminal unit control modules operable to control at least partially the operation of first and second terminal units, respectively; and
means for transmitting data packets from a processor to the transmit/receive module.

37. The system of claim 36, further comprising means for transmitting at least a portion of the control packets from the transmit/receive module to the first terminal unit.

38. The system of claim 36, further comprising means for transmitting information regarding the content of the first control packets from a script module to the first terminal unit control module.
